(19) United States
(12) Patent Application Publication
(10) Pub. No.: US 2008/0130459 A1
(43) Pub. Date: Jun. 5, 2008

(54) Information Recording Apparatus and Method, and Computer Program

(75) Inventors: Masahiro Kato, Saitama (JP); Tatsuhiro Yone, Saitama (JP); Kyusho Omori, Saitama (JP); Tohru Kanegae, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/792,415

(22) PCT Filed: Dec. 6, 2005
(86) PCT No.: PCT/JP05/22332

§ 371 Date: Jun. 6, 2007

(30) Foreign Application Priority Data
Dec. 6, 2004 (JP) 2004-353089

(51) Int. Cl. G11B 7/00

(52) U.S. Cl. 369/100

(57) ABSTRACT

An information recording apparatus (300) is for recording record information onto an information recording medium (100) provided with: a first area (112) to record therein the record information; and a second area (111) in which the record information is prerecorded as embossed pits, the information recording apparatus is provided with: a recording device (353) for recording the record information into the first area; a detecting device (354) for detecting that the record information is mistakenly recorded in the second area; and an erasing device (352) for erasing the mistakenly recorded record information.

### TECHNICAL FIELD

The present invention relates to an information recording apparatus and method, such as, e.g., a DVD recorder, and a computer program which makes a computer function as such an information recording apparatus.

### BACKGROUND ART

A hybrid-type optical disc, which has both a recordable recording area, as in a recordable type optical disc such as a CD-R and a DVD-R, and a read-only recording area, as in a read-only type optical disc such as a CD-ROM and a DVD-ROM, separately in an inner circumference, intermediate circumference, outer circumference, or combination thereof, out of one optical disc, is currently proposed and under development.

Specifically, the hybrid type optical disc has been practically used as a CPRM (Content Protection for Prerecorded Media)-compatible optical disc whose purpose is copyright protection of contents. In the CPRM-compatible optical disc, an encryption key for encrypting content data is prerecorded in the read-only recording area as embossed pits, and the content data is recorded into the recordable recording area using the encryption key. Even if it is attempted to illegally copy the content data from the read-only information recording medium such as a DVD-ROM into the CPRM-compatible optical disc, the encryption key cannot be recorded into the read-only recording area. Furthermore, even if it can be recorded, the encryption key cannot be read properly because the prerecorded embossed pits and newly recorded record marks interfere with each other. Therefore, as a result, it does not allow the illegal copy of the content data, and it allows preferable protection of the copyright of the content data.

On the other hand, a patent document 1 discloses a technology to generate recording-synchronizing signals on the basis of both or either of RF data signals and pre-pit signals, which are included in read signals detected in a control data zone. Thus, even if the embossed pits are formed in the control data zone, or even if land pre-pits are formed, a recording operation can be properly performed. In addition, a patent document 2 discloses such a technology that if address information and frequency signals are formed as the land pre-pits, the side surfaces of land tracks are changed, as occasion demands, in accordance with the formed area, to thereby certainly perform copyright protection.

Patent document 1: Japanese Patent Application Laying Open NO. 2002-150557
Patent document 2: Japanese Patent Application Laying Open NO. 2001-344764

### DISCLOSURE OF INVENTION

### Subject to be Solved by the Invention

However, in the case where the content data or the like is recorded onto the hybrid-type optical disc, the content data or the like may be sometime mistakenly recorded into the read-only area where the embossed pits or the like are formed in advance. The reason is as follows. In the manufacturing process of the hybrid-type optical disc, a recording film which is intended to record therein the data by using the record marks formed by irradiating laser light is further laminated on the embossed pits. Thus, by irradiating the laser light on the recording film formed on the embossed pits, the record marks may be formed on the embossed pits. In this case, the embossed pits and the newly formed record marks interfere with each other, and this interference causes such a technical problem that it is hard or impossible to preferably read the data indicated by the embossed pits and the data indicated by the record marks.

In order to solve the above-mentioned conventional problems, it is therefore an object of the present invention to provide an information recording apparatus and method, which can preferably perform data recording with respect to a hybrid-type information recording medium, and a computer program which makes a computer function as such an information recording apparatus.

### Means for Solving the Object

(Information Recording Apparatus)

The above object of the present invention can be achieved by an information recording apparatus for recording record information onto an information recording medium provided with: a first area to record therein the record information; and a second area in which the record information is prerecorded as embossed pits, the information recording apparatus provided with: a recording device for recording the record information into the first area; a detecting device for detecting that the record information is mistakenly recorded in the second area by the recording device; and an erasing device for erasing the mistakenly recorded record information.

According to the information recording apparatus of the present invention, by virtue of the operation of the recording device, the record information can be recorded into the first area provided for the information recording medium. The first area is a recordable recording area where the record information can be recorded, such as a DVD-R and a DVD-RW. On the other hand, the second area provided for the information recording medium is a so-called read-only recording area where the record information is prerecorded as the embossed pits having a predetermined physical shape, such as a DVD-ROM. Moreover, since the record information is prerecorded in the second area, the recording of the record information by the recording device is originally not performed. Namely, with regard to the information recording medium on which the recording information is recorded by the information recording apparatus of the present invention, for example, a hybrid type information recording medium can be listed as one specific example thereof.

Particularly in the present invention, during the recording of the record information by the operation of the recording device, it is judged whether or not the record information is mistakenly recorded into the second area, by the operation of the detecting device. Namely, it is detected that the record information is further mistakenly recorded as the record marks, for example, in the second area where the record information is already prerecorded as the embossed pits. If the mistakenly recording is detected, the mistakenly recorded record information is erased by the operation of the erasing device. As a result, the second area returns into the normal condition like before the record information is mistakenly recorded.

More specifically, in the first area, a recording film in which the record marks are formed by irradiating laser light with a predetermined power is formed (or laminated) in order to record the record information. Moreover, in the second area, the recording film is also formed (or laminated) on the embossed pits, because of the manufacturing process of the information recording medium. Thus, in the case where the record information is recorded onto the hybrid type information recording medium or the like, the record information may be sometimes mistakenly recorded into the second area by mistakenly irradiating the laser light onto the second area (particularly, on the recording film thereof where the record information is prerecorded as the embossed pits or the like. In this case, the embossed pits and the record marks formed on the recording film interfere with each other, and it is hardly possible to read (or reproduce) both the record information indicated by the record marks and the record information indicated by the embossed pits. Even in this case, according to the information recording apparatus of the present invention, by virtue of the operation of the erasing device, the record information mistakenly recorded as the record marks is erased, so that the embossed pits can be preferably read. Therefore, it is possible to preferably record the record information onto the hybrid type information recording medium or the like.

In addition, by virtue of the operation of the detecting device, the mistakenly recording is detected (or it is judged whether or not the mistakenly recording is performed) in parallel with the recording operation of recording the record information. Thus, if the record information is mistakenly recorded, the fact can be detected, quickly or immediately. Therefore, it is possible to stop the mistakenly recording of the record information as quickly as possible. Moreover, even if a user does not perform a special or particular operation, the detection of the mistakenly recording and the erasing of the mistakenly recorded record information can be performed by the operations of the detecting device and the erasing device, respectively. Namely, from the user's viewpoint, it seems as if the mistakenly recording of the record information did not happen at all.

Consequently, according to the information recording apparatus of the present invention, it is possible to preferably record the record information onto the information recording medium provided with the recording area where the record information can be recorded and the recording area where the recording of the record information is not allowed, like the hybrid type information recording medium or the like.

In one aspect of the information recording apparatus of the present invention, the detecting device further detects that the record information recorded in the first area is mistakenly erased by the erasing device, and the recording device records the mistakenly erased record information.

According to this aspect, in the case where the record information mistakenly recorded in the second area is erased by the operation of the erasing device, it is further detected by the operation of the detecting device whether or not the record information recorded in the first area is mistakenly erased. Namely, it is further detected that the record information which is originally not to be erased is mistakenly erased. Then, if the mistakenly erasing is detected, the mistakenly erased record information is recorded again into the first area (more preferably, into the first area where the mistakenly erasing is actually performed) by the operation of the recording device. As a result, the first area returns into the normal condition like before the record information is mistakenly erased. Thus, it is possible to preferably record the record information onto the hybrid type information recording medium or the like.

In another aspect of the information recording apparatus of the present invention, pre-pits for controlling the recording of the record information are formed in the first area, and the pre-pits are not formed in the second area, the information recording apparatus is further provided with a pit judging device for judging whether or not the pre-pits can be read, and the detecting device detects at least one of the mistakenly recording of the record information in the second area and the mistakenly erasing of the record information recorded in the first area, by judging whether a recording area where the record information is recorded or erased is the first area or the second area on the basis of whether or not the pre-pits can be read.

According to this aspect, if it is judged that the pre-pits can be read by the operation of the pit judging device, the recording area is judged to be the first area. On the other hand, if it is judged that the pre-pits cannot be read, the recording area is judged to be the second area. On the basis of the judgment, the detecting device can judge whether the recording area where the record information is recorded is the first area or the second area, relatively easily. Therefore, the detecting device can detect that the record information is mistakenly recorded in the second area, relatively easily. In addition, the detecting device can judge whether the recording area where the record information is erased is the first area or the second area, relatively easily. Therefore, the detecting device can detect that the record information which is recorded in the first area and which is originally not to be erased is mistakenly erased, relatively easily.

In an aspect of the information recording apparatus provided with the pit judging device, as described above, the pit judging device may change a slice level, which is a reference signal level when the pit judging device judges whether or not the pre-pits can be read, depending on whether the record information is recorded by the recording device or the record information is erased by the erasing device.

For example, in case of the information recording apparatus for recording or erasing the record information by irradiating the laser light, power of the laser light during the recording is different from that of the laser light during the erasing. Alternatively, even in case of another information recording apparatus, the recording power and the erasing power are different. Therefore, by virtue of such construction, even the record information is being recorded or is being erased, it can be preferably judged whether or not the pre-pits can be read by changing the slice level, as occasion demands. As a result, it is possible to preferably detect the mistakenly recording of the record information or the mistakenly erasing of the record information.

In an aspect of the information recording apparatus provided with the pit judging device, as described above, the detecting device may detect that the record information is mistakenly recorded if it is judged that the recording area where the record information is recorded is the second area. Moreover, the detecting device may detect that the record information recorded in the first area is mistakenly erased if it is judged that the recording area where the record information is erased is the first area.

By virtue of such construction, it is possible to preferably detect the mistakenly recording of the record information or the mistakenly erasing of the record information.

In an aspect of the information recording apparatus provided with the pit judging device, as described above, it is further provided with a timing judging device for judging whether or not timing at which a synchronization pattern included in the pre-pits appears is substantially equal to timing at which the synchronization pattern included in the record information which is a recording target appears, during the recording of the record information, the pit judging device judging whether or not the pre-pits can be read by that the timing judging device judges whether or not the timings are substantially equal.

By virtue of such construction, it is judged that the pre-pits can be read, only if the timing at which the synchronization pattern included in the pre-pits appears and the timing at which the synchronization pattern included in the record information appears are equal, or substantially equal, or are regarded as being equal and the pre-pits are read. By this, it is possible to preferably prevent that it is mistakenly judged that the pre-pits can be read, by detecting a noise component or the like. It is also possible to highly accurately judge whether or not the pre-pits can be read.

In an aspect of the information recording apparatus provided with the timing judging device, as described above, the timing judging device may judge whether or not the timing at which the synchronization pattern included in the pre-pits appears is substantially equal to timing at which the synchronization pattern prepared in a pseudo manner appears, during the erasing of the mistakenly recorded record information.

Since the record information is not recorded during the erasing of the record information, the synchronization pattern included in the record information cannot be recognized, as described above. However, by virtue of such construction, the synchronization pattern included in the record information can be prepared in the pseudo manner even during the erasing of the record information, so that it is possible to compare with the timing at which the synchronization pattern included in the pre-pits appears. Moreover, the synchronization pattern is necessarily prepared during the recording of the record information. Thus, in the same manner, it is also possible to prepare the synchronization pattern in the pseudo manner during the erasing, relatively easily. By this, it is possible to preferably prevent that it is mistakenly judged that the pre-pits can be read, by detecting a noise component or the like. It is also possible to highly accurately judge whether or not the pre-pits can be read.

In another aspect of the information recording apparatus of the present invention, it is further provided with a first level judging device for judging whether or not an average value of a signal detection level when the record information is recorded is less than a predetermined first threshold value, the detecting device detects, in a recording area where the average value that is less than the first threshold value is detected, that the record information is mistakenly recorded.

According to this aspect, as detailed later, it is possible to judge whether the recording area where the record information is recorded is the first area or the second area, by using the fact that the signal detection level (or the average value thereof) when the record information is recorded in the first area does not match the signal detection level (or the average value thereof) when the record information is recorded in the second area. In particular, a numerical value between the signal detection level (or the average value thereof) when the record information is recorded in the first area and the signal detection level (or the average value thereof when the record information is recorded in the second area is preferably set to the predetermined first threshold value. By this, it is possible to detect that the record information is mistakenly recorded in the second area, relatively easily.

In another aspect of the information recording apparatus of the present invention, it is further provided with a second level judging device for judging whether or not an average value of a signal detection level when the record information is erased is less than a predetermined second threshold value, the detecting device detects, in a recording area where the average value that is greater than the second threshold value is detected, that the record information in the first area is mistakenly erased.

According to this aspect, as detailed later, it is possible to judge whether the recording area where the record information is erased is the first area or the second area, by using the fact that the signal detection level (or the average value thereof) when the record information is erased in the first area does not match the signal detection level (or the average value thereof) when the record information is erased in the second area. In particular, a numerical value between the signal detection level (or the average value thereof when the record information is erased in the first area and the signal detection level (or the average value thereof) when the record information is erased in the second area is preferably set to the predetermined second threshold value. By this, it is possible to detect that the record information recorded in the first area is mistakenly erased, relatively easily.

(Information Recording Method)

The above object of the present invention can be also achieved by an information recording method of recording record information onto an information recording medium provided with: a first area to record therein the record information; and a second area in which the record information is prerecorded as embossed pits, the information recording method provided with: a recording process of recording the record information into the first area; a detecting process of detecting that the record information is mistakenly recorded in the second area by the recording device; and an erasing process of erasing the mistakenly recorded record information.

According to the information recording method of the present invention, it is possible to receive the same various benefits as those of the above-mentioned information recording apparatus of the present invention.

Incidentally, in response to the various aspects of the information recording apparatus of the present invention described above, the information recording method of the present invention can adopt various aspects.

(Computer Program)

The above object of the present invention can be also achieved by a computer program for recording control to control a computer provided in the above-mentioned information recording apparatus of the present invention (including its various aspects), the computer program making the computer function as at least one portion of the recording device and the erasing device.

According to the computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the information recording apparatus of the present invention described above, the computer program of the present invention can adopt various aspects.

The above object of the present invention can be also achieved by a computer program product in a computer-readable medium for tangibly embodying a program of instructions executable by a computer provided in the above-mentioned information recording apparatus of the present invention (including its various aspects), to make the computer function as at least one portion of the recording device and the erasing device.

According to the computer program product of the present invention, the above-mentioned information recording apparatus can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus.

These effects and other advantages of the present invention will become more apparent from the following embodiments.

As explained above, according to the information recording apparatus of the present invention, it is provided with: the recording device, the detecting device, and the erasing device. According to the information recording method of the present invention, it is provided with: the recording process, the detecting process, and the erasing process. Therefore, it is possible to preferably record the record information onto the hybrid type information recording medium or the like.

### BRIEF DESCRIPTION OF DRAWINGS

FIG. 1 is a substantial plan view showing the basic structure of an optical disc onto which data is recorded by an embodiment of the information recording apparatus of the present invention, showing the structure of the optical disc having a plurality of recording areas in the substantial plan view in the upper part, showing a corresponding area structure in the radial direction in a conceptual view in the lower part.

FIG. 2 is a partially enlarged perspective view showing a partial recording surface of the optical disc in the embodiment.

FIG. 3 is a partially enlarged perspective view showing another partial recording surface of the optical disc in the embodiment.

FIG. 4 is a block diagram showing the basic structure of a host computer and an information recording apparatus as a first embodiment of the information recording apparatus of the present invention.

FIG. 5 is a block diagram showing the basic structure of a LPP judgment device provided for the information recording apparatus in the first embodiment.

FIG. 6 is a flowchart showing a flow of the entire recording operation of the information recording apparatus in the first embodiment.

FIG. 7 is a signal waveform diagram showing a relationship between a RF signal and a push-pull signal in a DVD-R which is one specific example of the optical disc.

FIG. 8 are signal waveform diagrams showing a relationship between a RF signal and a push-pull signal in a DVD-RW which is one specific example of the optical disc.

FIG. 9 are data structure diagrams conceptually showing the erasing of mistakenly recorded data and the recording of mistakenly erased data.

FIG. 10 are signal waveform diagrams showing the RF signal when embossed pits formed in a read-only area are reproduced, upon the data recording and erasing.

FIG. 11 is a block diagram showing the basic structure of a host computer and an information recording apparatus as a second embodiment of the information recording apparatus of the present invention.

FIG. 12 is a block diagram showing the basic structure of a mistakenly recording/mistakenly erasing detector provided for the information recording apparatus in the second embodiment.

FIG. 13 is a flowchart showing a flow of the entire recording operation of the information recording apparatus in the second embodiment.

FIG. 14 are signal waveform diagrams showing a sum signal during the data recording.

FIG. 15 is an explanatory diagram explaining a principle of detecting the mistakenly recording of the data on the basis of the sum signal during the data recording.

FIG. 16 are signal waveform diagrams showing a sum signal during the data erasing.

FIG. 17 is an explanatory diagram explaining a principle of detecting the mistakenly erasing of the data on the basis of the sum signal during the data erasing.

### DESCRIPTION OF REFERENCE CODES

100 optical disc
106 user data area
111 read-only area
112 recordable area
300 information recording/reproducing apparatus
352 optical pickup
353 signal recording/reproducing device
354 CPU
401 LPP judgment device
402 mistakenly recording/mistakenly erasing detector
410 push-pull signal generator
421 adder circuit
413, 423 switch
414, 424 first reference voltage supply circuit
415, 425 second reference voltage supply circuit
416, 426 converter
417 14T pattern gate circuit
418 14T mark/space signal extraction circuit
429 LPF

### BEST MODE FOR CARRYING OUT THE INVENTION

Hereinafter, the best mode for carrying out the present invention will be explained in each embodiment in order on the basis of the drawings.

(Information Recording Medium)

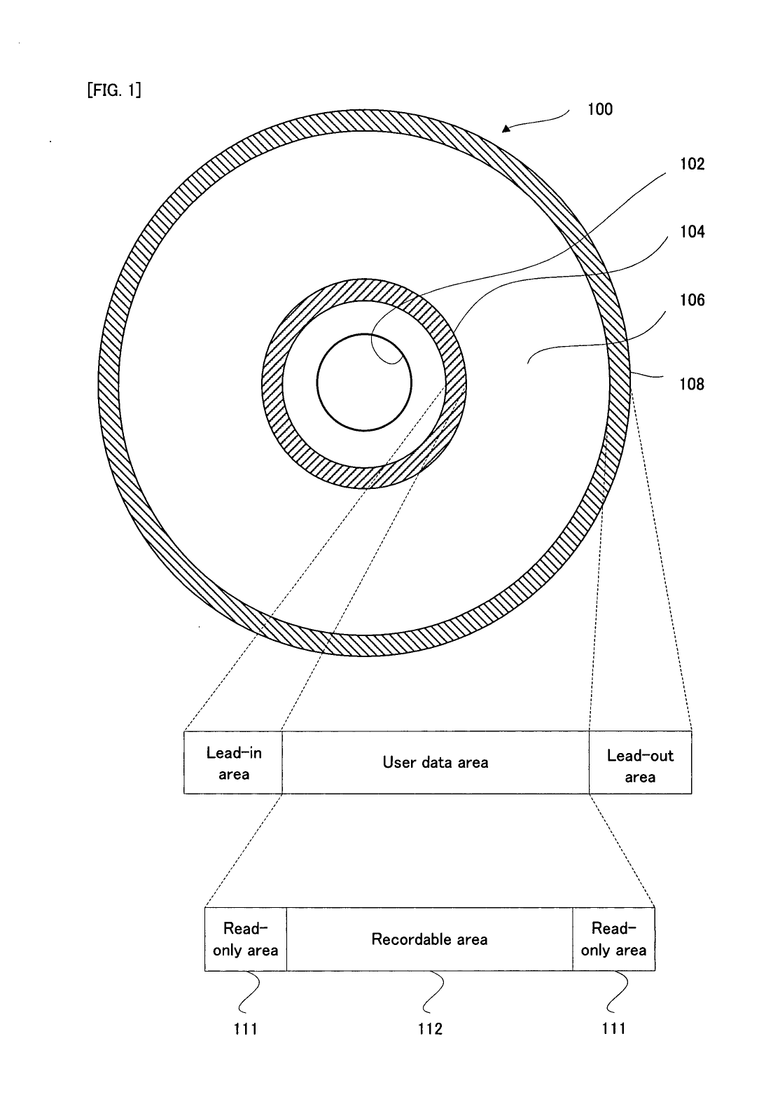

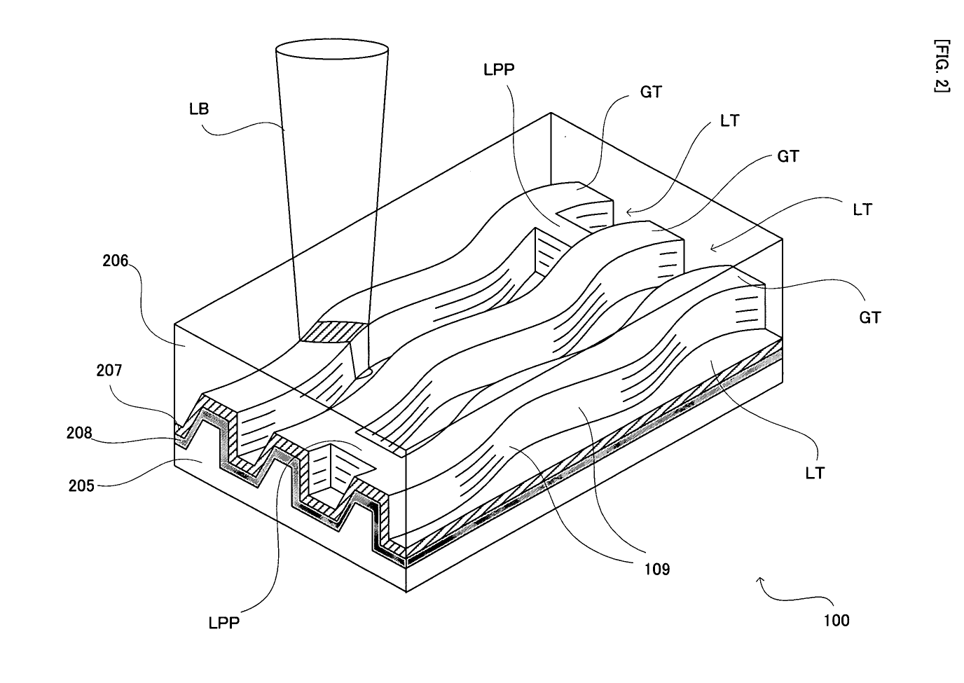

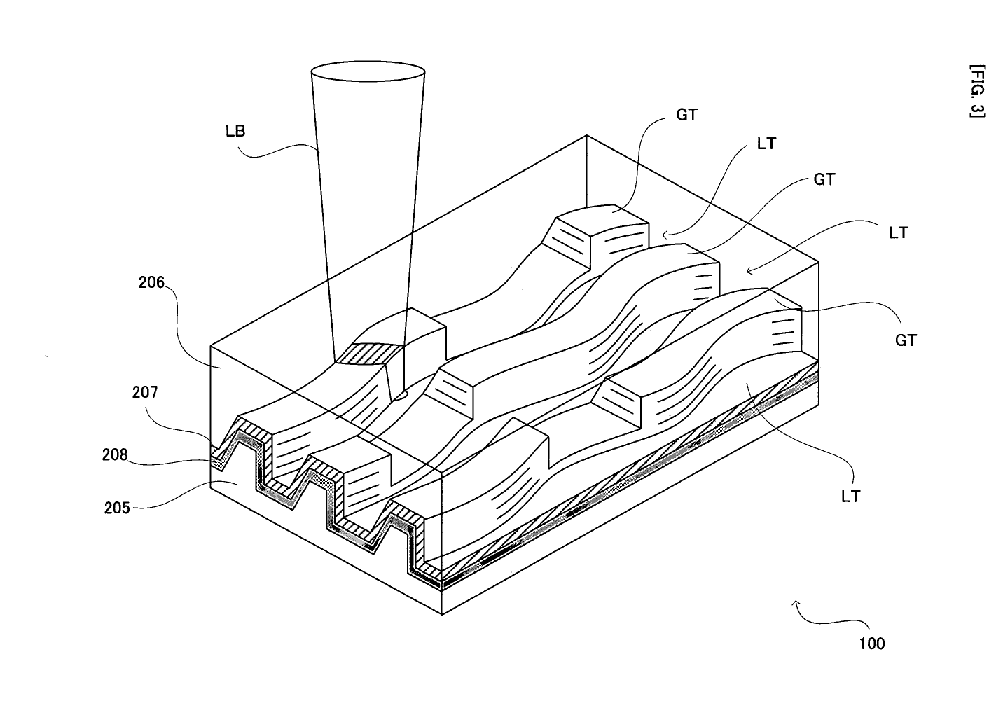

Firstly, with reference to FIG. 1 and FIG. 2, an explanation will be given for an optical disc onto which data is recorded by an embodiment of the information recording apparatus of the present invention. FIG. 1 shows the structure of the optical disc having a plurality of recording areas in the substantial plan view in the upper part, and shows a corresponding area structure in the radial direction in a conceptual view in the lower part. Each of FIG. 2 and FIG. 3 is a partially enlarged perspective view showing a partial recording surface of the optical disc in the embodiment.

As shown in FIG. 1, an optical disc 100 has a recording surface on a disc main body with a diameter of about 12 cm, as is a DVD. On the recording surface, the optical disc 100 is provided with: a center hole 102 as the center; a lead-in area 104; a user data area 106; and a lead-out area 108, from an inner circumferential side to an outer circumferential side. Then, in each area, groove tracks GT and land tracks LT are alternately placed, spirally or concentrically, centered on the center hole 102. The groove tracks GT may be wobbled, and pre-pits may be formed on one or both of the groove tracks and the land tracks.

Incidentally, the present invention is not particularly limited to the optical disc having these three areas. For example, even if the lead-in area 104 and the lead-out area 108 do not exist, a data structure explained below can be constructed. Moreover, as described later, the lead-in area 104 and the lead-out area 108 may be further segmentalized.

Particularly in the embodiment, as shown in the lower part of FIG. 1, the user data area 106 includes: one or a plurality of read-only areas 111, which constitute one specific example of the “second area” of the present invention; and one or a plurality of recordable areas 112, which constitute one specific example of the “first area” of the present invention.

In the read-only area 111, predetermined data is prerecorded by using embossed pits, each of which has a predetermined physical shape, as in the recording area provided for a DVD-ROM or the like.

The recordable area 112 is a recording area in which data can be recorded a plurality of times or only once in various recording methods, such as a magneto optical method and a phase change method. Therefore, a user can record various content data, such as video contents, audio contents, or contents for PC, into the recordable area out of the user data area 106, by the operation of an information recording apparatus 300 described later.

Moreover, the optical disc 100 is not limited to a one-layer optical disc, but may be a two-layer single sided type, i.e., a dual layer type, or a two-layer double sided type, i.e., a dual layer double sided type. Furthermore, the optical disc 100 is not limited to the optical disc having the two recording layers, as described above, but may be an optical disc of a multilayer type which has three or more layers.

Moreover, as shown in FIG. 2, in the recordable area 112 of the optical disc 100, a phase-change type recording layer 207 which constitutes an information recording surface is laminated on a disc-shaped transparent substrate 206 (on the lower side in FIG. 2), and a reflective film 208 is laminated thereon (on the lower side in FIG. 2). Moreover, a protective layer 205 is formed on the reflective film 208 (on the lower side in FIG. 2), to thereby protect the optical disc 100 from dusts and scratches or the like from the exterior. On the information recording surface constructed from the surface of the recording layer 207, the groove tracks GT and the land tracks LT are alternately formed. Incidentally, upon recording and reproduction of the optical disc 100, for example, as shown in FIG. 2, laser light LB is irradiated onto the groove track GT via the transparent substrate 206. For example, upon recording, the laser light LB is irradiated with a recording power, and phase-change recording is performed by heat or the like with respect to the recording layer 207 in accordance with the record data. On the other hand, upon reproduction, the laser light LB is irradiated with a reproduction power, which is weaker than the recording power, by which the record data written in the recording layer 207 is read.

Moreover, the groove track GT is oscillated with a constant amplitude and at a constant spatial frequency. Namely, the groove track GT is wobbled, and the cycle of the wobble 109 is set to a predetermined value. On the land track LT, there is formed an address pit which is referred to as a land pre-pit LPP and which indicates pre-format address information (i.e. a pit corresponding to one specific example of the “pre-pit” of the present invention). By virtue of the two addressing (i.e. the wobble 109 and the land pre-pit LPP), it is possible to obtain information necessary for (i) disc rotation control during the recording, (ii) generation of a recording clock, or (iii) data recording, such as a recording address. Incidentally, it is also possible to prerecord the pre-format address by modulating the wobble 109 of the groove track GT in a predetermined modulation method, such as frequency modulation and phase modulation.

Moreover, as shown in FIG. 3, in the read-only area 111 of the optical disc 100, as in the recordable area 112 shown in FIG. 2, the recording layer 207 is laminated on the transparent substrate 206, and the reflective film 208 is laminated on the recording layer 207. Moreover, the protective layer 205 is formed on the reflective film 208. Particularly in the read-only area 111, the embossed pits are formed by changing the heights of the groove tracks GT having such a lamination structure as occasion demands (or by forming space portions or concave portions). The embossed pits are reproduced by irradiating the groove track GT with the laser light LB with a reproduction power. Moreover, the land pre-pit LPP is not formed in the read-only area 111.

### FIRST EMBODIMENT

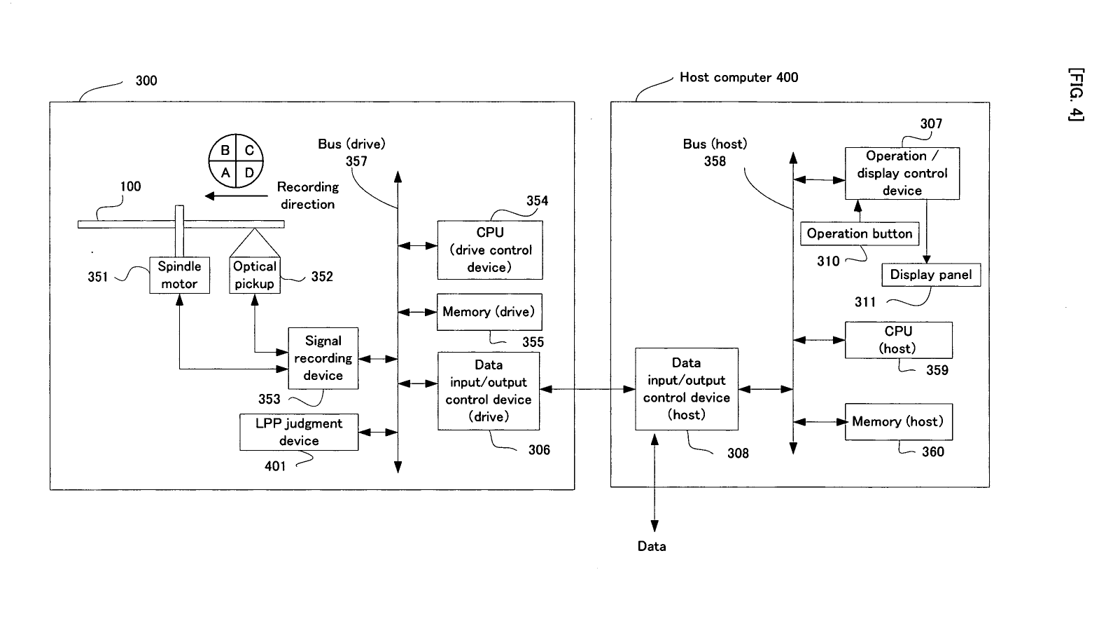

Next, with reference to FIG. 4 to FIG. 10, the first embodiment of the information recording apparatus of the present invention will be explained.

(1) Basic Structure

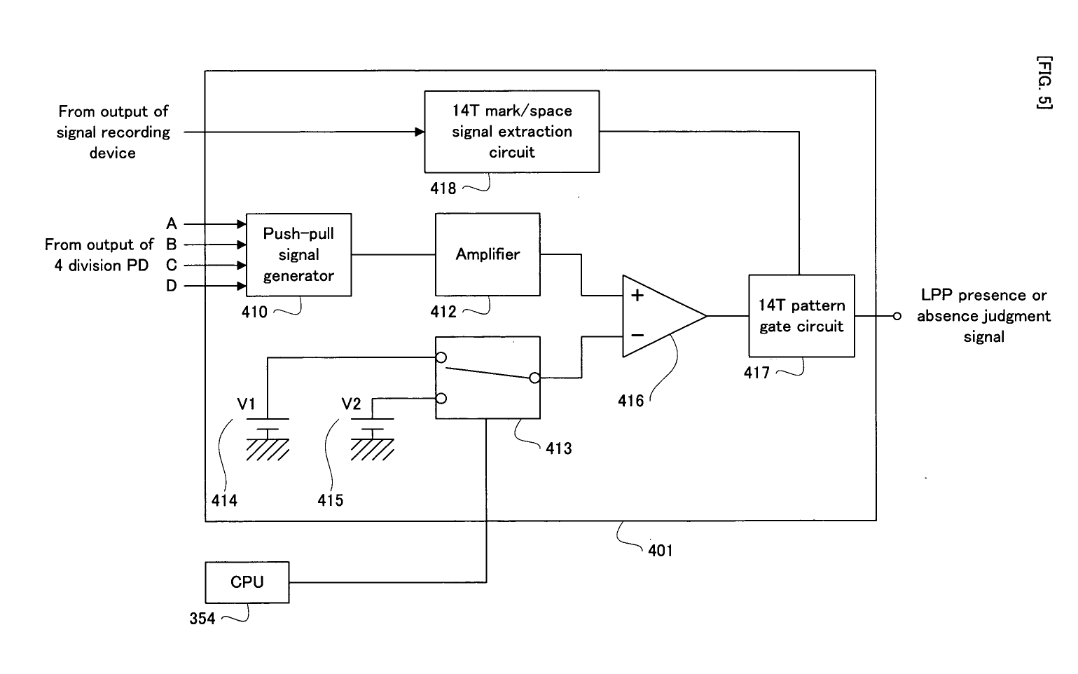

Firstly, with reference to FIG. 4 and FIG. 5, the basic structure of the information recording apparatus in the first embodiment will be explained. FIG. 4 is a block diagram showing the basic structure of a host computer and the information recording apparatus in the first embodiment. FIG. 5 is a block diagram showing the basic structure of a LPP judgment device provided for the information recording apparatus in the first embodiment.

With reference to FIG. 4, the inner structure of an information recording apparatus 300 will be explained. The information recording apparatus 300 is an apparatus for recording information onto the optical disc 100, under the control of a CPU (Central Processing Unit) for drive.

The information recording apparatus 300 is provided with: the optical disc 100; a spindle motor 351; an optical pickup 352; a signal recording device 353; the CPU (drive control device) 354; a memory 355; a data input/output control device 306; a bys 357; and a LPP detection device 401. Moreover, a host computer 400 is provided with: a CPU 359; a memory 360; an operation/display control device 307; an operation button 310; a display panel 311; a bust 358; and a data input/output control device 308.

The spindle motor 351 is intended to rotate and stop the optical disc 100, and operates upon accessing the optical disc 100. More specifically, the spindle motor 351 is adapted to rotate the optical disc 100 at a predetermined speed and stop it, under spindle servo from a not-illustrated servo unit or the like.

The optical pickup 352 constitutes one example of the “recording device” and the “erasing device” of the present invention. The optical pickup 352 is provided with a semiconductor laser apparatus, a lens, and the like, in order to record the data onto the optical disc 100. More specifically, the optical pickup 352 irradiates the laser light LB onto the optical disc 100, with a predetermined power as writing light and with it modulated. Moreover, upon the data erasing, it irradiates the laser light LB with a predetermined power as erasing light.

The signal recording device 353 constitutes one specific example. The signal recording device 353 controls the spindle motor 351 and the optical pickup 352, to thereby perform the recording with respect to the optical disc 100. More specifically, the signal recording/reproducing device 353 is provided with: a laser diode (LD) driver; a head amplifier; and the like, for example. The laser diode driver (LD driver) drives a not-illustrated semiconductor laser device located in the optical pickup 352. The head amplifier amplifies the output signal of the optical pickup 352, i.e. the reflective light of a light beam, and outputs the amplified signal. More specifically, the signal recording/reproducing device 353 drives the not-illustrated semiconductor laser device located in the optical pickup 352, so as to determine an optimum laser power by the recording and reproduction processes for an OPC (Optimum Power Control) pattern, together with a not-illustrated timing generator or the like, under the control of the CPU 354, upon an OPC process.

The memory 355 is used in the whole data processing and the OPC process or the like on the information recording apparatus 300, including a buffer area for data to be recorded, an area used as an intermediate buffer when data is converted into the data that can be used on the signal recording device 353, and the like. Moreover, the memory 355 is provided with: a ROM area into which a program for performing an operation as a recording device, i.e. firmware, is stored; a buffer for temporary storage of the data to be recorded; a RAM area into which a parameter required for the operation of a firmware program or the like is stored; and the like.

The CPU (drive control device) 354 is connected to the signal recording device 353 and the memory 355 via the bus 357, and controls the entire information recording apparatus 300 by giving an instruction to various controlling devices. Normally, software or firmware for operating the CPU 354 is stored in the memory 355.

The data input/output control device 306 controls the input/output of the data from the exterior with respect to the information recording apparatus 300, to thereby perform storage to and export from the data buffer on the memory 355. A drive control command issued from the external host computer 400 (hereinafter referred to as a “host”, as occasion demands) connected to the information recording apparatus 300 through an interface, such as a SCSI and an ATAPI, is transmitted to the CPU 354 through the data input/output control device 306. Moreover, the data to be recorded is also exchanged with the host computer 400 through the data input/output control device 306, in the same manner.

The operation/display control device 307 receives an operation instruction and performs display with respect to the host computer 400, and transmits an instruction by the operation button 310, such as an instruction to “record”, to the CPU 359. The CPU 359 transmits a control command to the information recording apparatus 300, through the data input/output control device 308, on the basis of instruction information from the operation/display control device 307, to thereby control the entire information recording apparatus 300. In the same manner, the CPU 359 can transmit a command for requesting the information recording apparatus 300 to transmit an operational state to the host, with respect to the information recording apparatus 300. By this, the operational state of the information recording/apparatus 300, such as during recording, can be recognized, so that the CPU 359 can output the operational state of the information recording apparatus 300 to the display panel 311, such as a fluorescent tube and an LCD, through the operation/display control device 307.

The memory 360 is an internal memory device used by the host computer 400, and is provided, for example, with a ROM area into which a firmware program, such as BIOS (Basic Input/Output System), is stored; a RAM area into which variables necessary for the operations of an application program, an operating system, and the like are stored; and the like. Moreover, the memory 360 may be connected to a not-illustrated external memory device, such as a hard disk, via the data input/output device 308.

The information recording apparatus 300 in the first embodiment is particularly provided with the LPP judgment device 401, which constitutes one specific example of the “pit judging device” of the present invention. The LPP judgment device 401 is adapted to judge whether or not the land pre-pit LPP exists (or whether or not the presence of the land pre-pit LPP can be detected) in the recording area where the data is currently being recorded.

The structure of the LPP judgment device 401 will be explained, more specifically, with reference to FIG. 5. As shown in FIG. 5, the LPP judgment device 401 is provided with: a push-pull signal generator 410; an amplifier 412; a switch 413; a first reference voltage supplier 414; a second reference voltage supplier 415; a comparator 416; a 14T pattern gate circuit 417; and a 14T mark/space signal extraction circuit 418.

The push-pull signal generator 410 is adapted to calculate (a+d)−(b+c) by using divisional read signals a, b, c, and d, and generate a push-pull signal. At this time, the optical pickup 352 is provided with a not-illustrated four-division photo detector (PD), and outputs, as the divisional read signals a, b, c, and d, a signal corresponding to the quantity of reflected light of the laser light LB which corresponds to respective one of four areas A, B, C, and D divided in the recording direction (the traveling direction of the optical pickup 352) as shown in the upper part of FIG. 4. The component (a+d) corresponds to the areas A and D which are on the left side with respect to the reading direction, while the component (b+c) corresponds to the areas B and C which are on the right side with respect to the reading direction. The value of the push-pull signal indicates a relative position relationship between the laser light LB and the pit.

The amplifier 412 is adapted to amplify the push-pull signal outputted from the push-pull signal generator 410. Then, the amplified push-pull signal is inputted to one of input terminals of the comparator 416.

The switch 413 is adapted to change a reference voltage (slice level) inputted to the other input terminal of the comparator 416 to either a voltage V1 which is the output of the first reference voltage supplier 414 or a voltage V2 which is the output of the second reference voltage supplier 415. The changing of the switch 413 is performed under the control of the CPU 354, for example.

The first reference voltage supplier 414 is adapted to output the voltage V1 as the reference voltage inputted to the other input terminal of the comparator 416. In particular, the voltage V1 outputted from the first reference voltage supplier 414 is inputted to the other input terminal of the comparator 416 when the information recording apparatus 300 records the data. Moreover, with regard to the value of the voltage V1, it is preferable to set a more proper predetermined value, individually and specifically (e.g. depending on the power or the like of the laser light LB when the data is recorded), experimentally, experientially, mathematically or theoretically, or using simulations or the like, depending on the characteristics of the actually recorded data.

The second reference voltage supplier 415 is adapted to output the voltage V2 as the reference voltage inputted to the other input terminal of the comparator 416. In particular, the voltage V2 outputted from the second reference voltage supplier 415 is inputted to the other input terminal of the comparator 416 when the information recording apparatus 300 erases the data. Moreover, with regard to the value of the voltage V2, it is preferable to set a more proper predetermined value, individually and specifically (e.g. depending on the power or the like of the laser light LB when the data is erased), experimentally, experientially, mathematically or theoretically, or using simulations or the like, depending on the characteristics of the actually erased data.

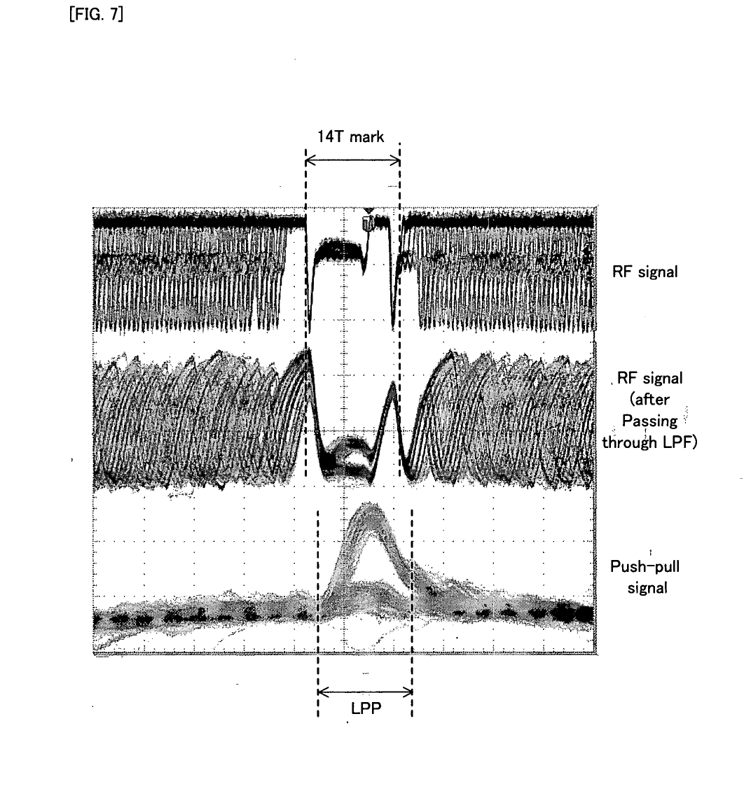

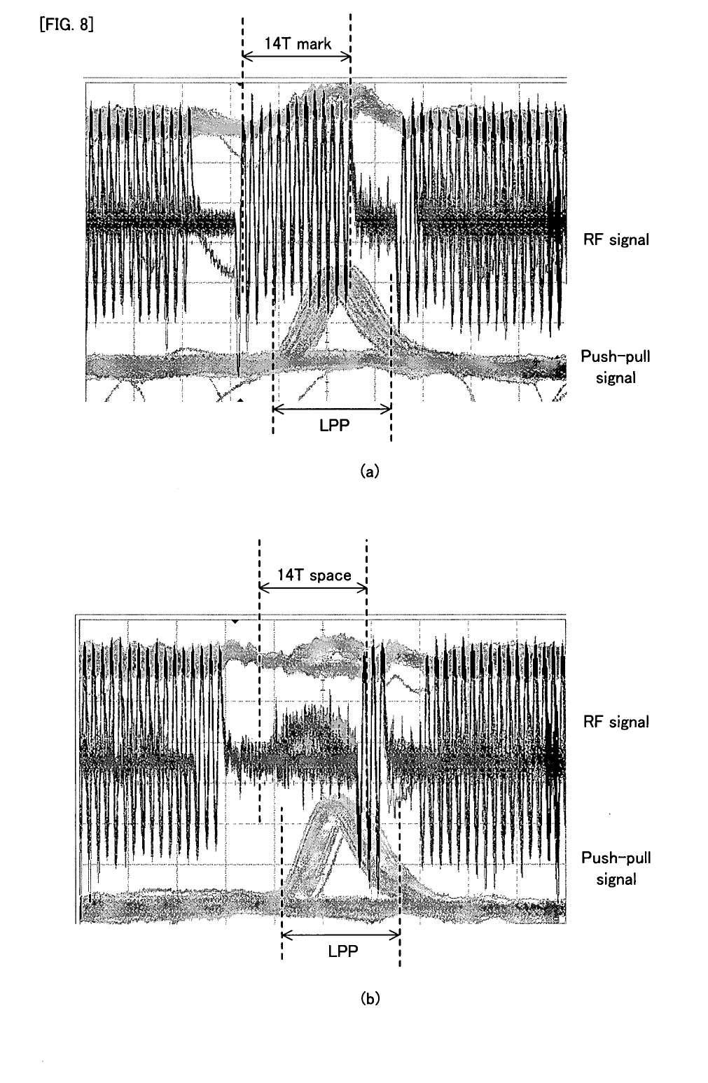

The comparator 416 is adapted to compare the push-pull signal outputted from the amplifier 412 with the voltage V1 outputted from the first reference voltage supplier 414 or the voltage V2 outputted from the second reference voltage supplier 415, to thereby output a LPP signal. Namely, the comparator 416 is adapted to output, e.g., a binary LPP signal, on the basis of a signal obtained by subtracting the voltage V1 or V2 from the push-pull signal (refer to FIG. 7 and FIG. 8).

The 14T pattern gate circuit 417 constitutes one specific example of the “timing judging device” of the present invention. The 14T pattern gate circuit 417 is adapted to judge whether or not the land pre-pit LPP exists on the basis of the LPP signal outputted from the comparator 416, with a 14T mark or 14T space extracted by the 14T mark/space signal extraction circuit 418 as a gate signal.

The 14T mark/space signal extraction circuit 418 is adapted to extract the 14T mark or 14T space included in the data to be recorded (in other words, the RF signal corresponding to the data to be recorded) and output it to the 14T pattern gate circuit 417.

One specific example used by combining the information recording apparatus 300 and the host computer 400, as explained above, is household equipment, such as recorder equipment for recording video images. The recorder equipment records a video signal from a broadcast reception tuner and an external connection terminal, onto a disc. The operation as the recorder equipment is performed by executing a program stored in the memory 360, on the CPU 359. Moreover, in another specific example, the information recording apparatus 300 is a disc drive (hereinafter referred to as a “drive”, as occasion demands), and the host computer 400 is a personal computer and a work station. The host computer, such as the personal computer, and the disc drive are connected through the data input/output control devices 306 and 308, such as the SCSI and the ATAPI, and application, such as writing software, installed in the host computer 400 controls the disc drive.

Incidentally, the information recording apparatus 300 in the first embodiment may have a function of reproducing the data recorded on the optical disc 100. For example, the signal recording device 353 may have a function of reproducing the data recorded on the optical disc 100. Namely, it may be constructed as an information recording/reproducing apparatus (or information reproducing apparatus).

(2) Recording Operation Example

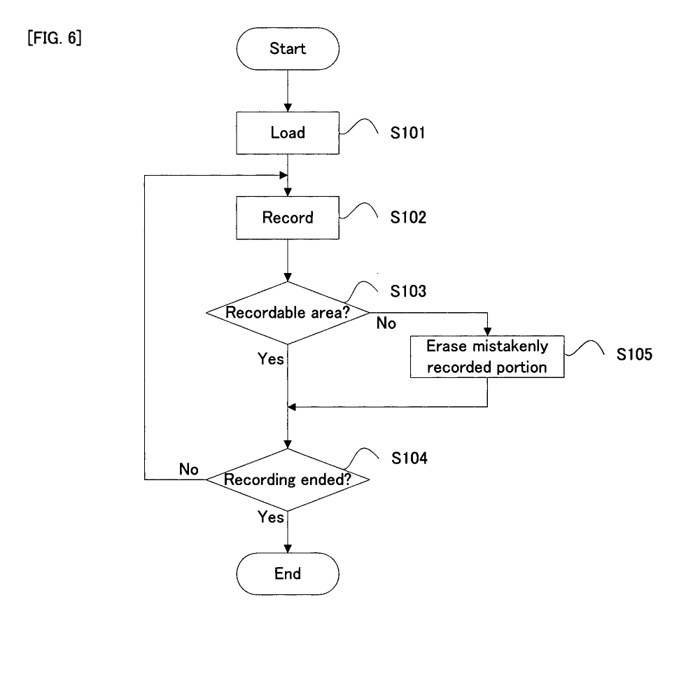

Next, with reference to FIG. 6 to FIG. 10, the recording operation by the information recording apparatus in the first embodiment will be explained. Here, firstly, FIG. 6 to FIG. 8 are referred to for explanation of the general recording operation, and then, the other drawings are used for detailed explanation. FIG. 6 is a flowchart showing a flow of the entire recording operation of the information recording apparatus in the first embodiment. FIG. 7 is a signal waveform diagram showing a relationship between a RF signal and a push-pull signal in a DVD-R which is one specific example of the optical disc. FIG. 8 are signal waveform diagrams showing a relationship between a RF signal and a push-pull signal in a DVD-RW which is one specific example of the optical disc.

As shown in FIG. 6, firstly, the optical disc 100 is loaded on the information recording apparatus 300 (step S101). At this time, control information or the like (e.g. write strategy, etc.) for controlling the recording operation may be read, or OPC (Optimum Power Control) may be performed to calculate an optimum power of the laser light LB upon the recording.

Then, data is actually recorded onto the optical disc 100 (step S102). Namely, an ECC (Error Correction) code for error correction is appended in accordance with the data to be recorded. Moreover, for example, after 8-16 modulation is performed, the optical disc 100 is irradiated with the laser light LB with a predetermined power and a predetermined waveform. By this, for example, 3T to 11T or 14T record marks or record spaces are combined, to thereby record the predetermined data.

At this time, in parallel with the recording operation, it is judged whether or not the recording area where the data is currently being recorded is the recordable area 112 (step S103). Specifically, it is judged on the basis of the presence or absence of the land pre-pit LPP detected by the operation of the LPP judgment device 401. Namely, if it is detected by the LPP judgment device 401 that there is the land pre-pit LPP, it is judged to be the recordable area 112. On the other hand, if it is detected by the LPP judgment device 401 that there is no land pre-pit LPP, it is judged not to be the recordable area 112. At this time, the switch 413 provided for the LPP judgment device 401 is changed so as to input the voltage V1 outputted from the first reference voltage supplier 414 to the other input terminal of the comparator 416, under the control of the CPU 354.

In the judgment, the presence or absence of the land pre-pit LPP is detected on the basis of the LPP signal outputted from the comparator 416, by using the 14T mark or 14T space included in the RF signal when the recorded data is read as the gate signal as described above. This is to prevent such a disadvantage that it cannot be preferably judged whether or not the land pre-pits LPP exists, due to an influence of noise included in the push-pull signal.

For example, in the recording onto a DVD-R, which is one specific example of the optical disc 100, the 14T mark of the RF signal, shown in the top of FIG. 7, and the signal portion corresponding to the land pre-pit LPP (particularly, the land pre-pit LPP for synchronization, existing in the first wobble 109 with respect to a unit constructed from eight wobbles 109) of the push-pull signal (or the LPP signal), shown in the bottom of FIG. 7, substantially match (i.e. are synchronized) on a time axis, from the viewpoint of the standard of DVD-R. Alternatively, the 14T mark of the RF signal with a high-frequency component (e.g. a noise component) removed, shown in the middle of FIG. 7, and a signal component corresponding to the land pre-pit LPP of the push-pull signal, shown in the bottom of FIG. 7, substantially match on the time axis. Moreover, the same is also true for the 14T space of the RF signal.

Therefore, it is possible to prevent such a disadvantage that the noise component is mistakenly recognized as the signal component corresponding to the land pre-pit LPP for synchronization because a noise component is included in the push-pull signal, and that the land pre-pit LPP is judged to exist though the land pre-pit LPP does not exist. Namely, if there is no signal component corresponding to the land pre-pit LPP (particularly, the land pre-pit LPP for synchronization, existing in the first wobble 109 with respect to the unit constructed from eight wobbles) in the position corresponding to the 14T mark or 14T space included in the RF signal, then it is judged that there is no land pre-pit LPP. In other words, even if there is the signal component corresponding to the land pre-pit LPP, if there is no 14T mark nor 14T space included in the RF signal in the position, then it is judged that the land pre-pit LPP does not exist. Thus, by using the 14T mark or 14T space included in the LPP signal as the gate signal, it is possible to reduce or eliminate the influence of the noise component included in the LPP signal SL, to thereby highly accurately judge whether or not the land pre-pit LPP exists.

In the same manner, in the recording onto a DVD-RW, which is one specific example of the optical disc 100, the 14T mark of the RF signal, shown in the upper part of FIG. 8(a), and the signal portion corresponding to the land pre-pit LPP (particularly, the land pre-pit LPP for synchronization, existing in the first wobble 109 with respect to the unit constructed from eight wobbles 109) of the push-pull signal, shown in the lower part of FIG. 8, substantially match on the time axis, from the viewpoint of the standard of DVD-RW. Moreover, the 14T space of the RF signal, shown in the upper part of FIG. 8(b), and the signal portion corresponding to the land pre-pit LPP (particularly, the land pre-pit LPP for synchronization, existing in the first wobble 109 with respect to the unit constructed from eight wobbles 109) of the push-pull signal, shown in the lower part of FIG. 8(b), substantially match on the time axis. Therefore, even in case of such an optical disc 100, it can be highly accurately judged whether or not the land pre-pit LPP exists, as described above.

Simply, however, mere LPP signal outputted from the comparator 416 may be used to judge whether or not the land pre-pit LPP exists. Namely, if there is the signal portion corresponding to the land pre-pit LPP in the LPP signal, it may be judged that there is the land pre-pit LPP. However, since the LPP signal detected during the recording operation includes a large amount of noise components, it is preferable to use the 14T mark or 14T space included in the RF signal as the gate signal in order to highly accurately judge whether or not the land pre-pit LPP exists.

In FIG. 6 again, as a result of the judgment in the step S103, if it is judged that the recording area where the data is currently being recorded is the recordable area 112 (the step S103: Yes), it is recognized that the data is not mistakenly recorded into the read-only area 111, under the control of the CPU 354, which is one specific example of the “detecting device” of the present invention.

After that, it is judged whether or not to end the recording operation (step S104). For example, if all the data to be recorded is already recorded, it may be judged to end the recording operation. Alternatively, if a user gives an instruction to stop the recording, it may be judged to end the recording operation.

As a result of the judgment in the step S104, if it is judged not to end the recording operation (the step S104: No), the operational flow returns to the step S102 again to continue the recording operation. On the other hand, if it is judged to end the recording operation (the step S104: Yes), the recording operation is ended, and if necessary, a finalize process for the optical disc 100 may be performed, or the optical disc 100 may be ejected from the information recording apparatus 300.

On the other hand, as a result of the judgment in the step S103, if it is judged that the recording area where the data is currently being recorded is not the recordable area 112 (the step S103: No), it is recognized that the data is mistakenly recorded into the read-only area 111, under the control of the CPU 354, which is one specific example of the “detecting device” of the present invention. Namely, although the recording area where the data is currently being recorded is not the recordable area 112 (i.e. it is the read-only area 111 without the land pre-pit LPP), the data is recorded. Thus, it is recognized that the data is mistakenly recorded into the read-only area 111. Specifically, it is recognized that the record mark or the like is formed in the recording film 206 of the read-only area 111.

In this case, firstly, the recording operation of recording the data is temporarily stopped, and then the mistakenly recorded data is erased (step S105). Specifically, the mistakenly recorded data is erased by irradiating the recording area where the data is mistakenly recorded, out of the read-only area 111, with the laser light LB with a predetermined DC power (i.e. a power, which is an erasing power, smaller than the recording power when the data is recorded).

Moreover, at the time of this erasing operation, it may be judged whether or not the recording area where the data is currently being erased is the read-only area 111. Specifically, it is judged whether or not there is the land pre-pit LPP detected by the operation of the LPP judgment device 401. Namely, if it is judged that there is the land pre-pit LPP by the LPP judgment device 401, it may be judged not to be the read-only area 111. On the other hand, if it is judged that there is no land pre-pit LPP by the LPP judgment device 401, it may be judged to be the read-only area 111. At this time, in some cases, the erasing power is not the same as the recording power, so that the amplitude of the push-pull signal detected during the erasing operation is different from that of the push-pull signal detected during the recording operation. Therefore, with regard to the reference voltage when the LPP signal is generated, a voltage different from that in the recording operation needs to be used in the erasing operation. Thus, the switch 413 provided for the LPP judgment device 401 is changed so as to input the voltage V2 outputted from the second reference voltage supplier 415 to the other terminal of the comparator 416, under the control of the CPU 354.

Then, during the erasing of the mistakenly recorded data, it is impossible to extract the 14T mark or 14T space used as the gate signal, from the RF signal when the recorded data is read, by the operation of the 14T mark/space signal extraction circuit 418 shown in FIG. 5. Therefore, a virtually generated 14T mark or 14T space may be used as the gate signal. Namely, even during the erasing of the data, as in the recording of the data, the 14T mark or 14T space may be generated in predetermined timing and inputted to the 14T pattern gate circuit 417.

If it is judged to be the read-only area 111, it is recognized that the data recorded in the recordable area 112 is not mistakenly erased, under the control of the CPU 354. On the other hand, if it is judged not to be the read-only area 111 (i.e. to be the recordable area 112 with the land pre-pit LPP), it is recognized that the data recorded in the recordable area 112 is mistakenly erased, under the control of the CPU 354. Therefore, in the case where it is mistakenly erased, the erasing operation is preferably stopped to record the mistakenly erased data again, as in the erasing operation of erasing the mistakenly recorded data. At this time, various information for reconstructing the mistakenly erased data is preferably stored in the memory or the like.

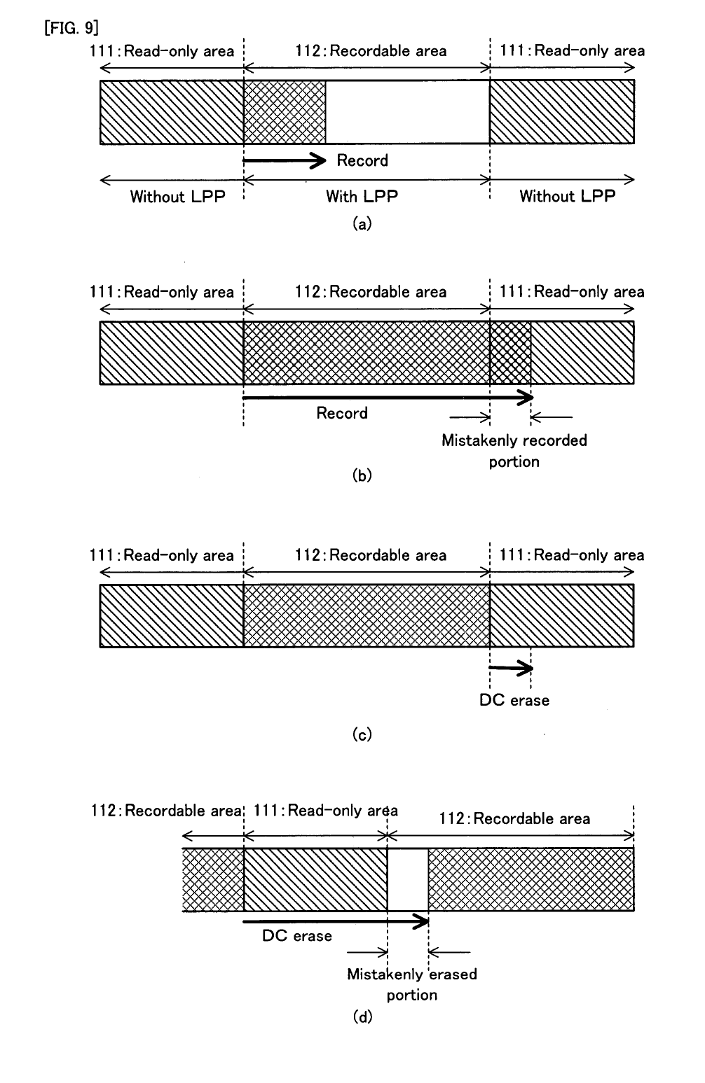

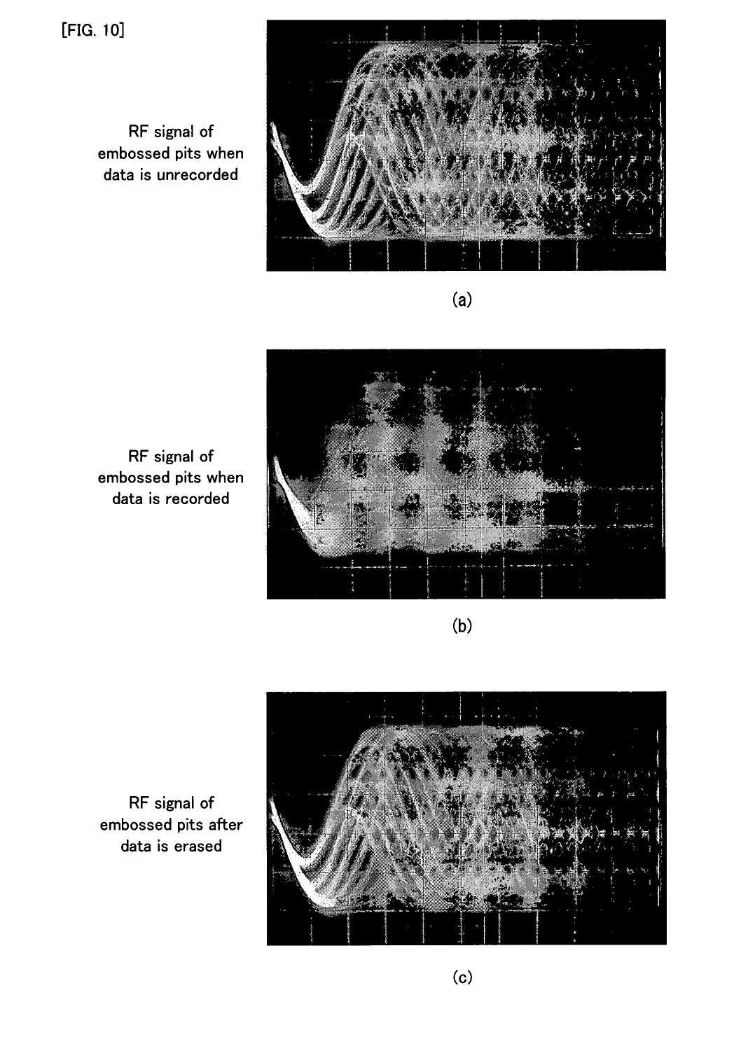

Specifically, the erasing operation of erasing the mistakenly recorded data and the recording operation of recording the mistakenly erased data will be explained with reference to an actual aspect of recording the data on the optical disc 100, shown in FIG. 9, and the RF signal which is the reproduction signal of the embossed pits, shown in FIG. 10. FIG. 9 are data structure diagrams conceptually showing the erasing of mistakenly recorded data and the recording of mistakenly erased data. FIG. 10 are signal waveform-diagrams showing the RF signal when embossed pits formed in the read-only area 111 are reproduced, upon the data recording and erasing.

As shown in FIG. 9(a), it is assumed that the data is recorded in the recordable area 112. At this time, in the LPP judgment device 401, the switch 413 is changed to the first reference voltage supplier 414 side, and it is judged whether or not the land pre-pit LPP exists. Then, in the middle of the recording operation shown in FIG. 9(a), it is judged that the land pre-pit LPP exists. Therefore, in the judgment in the step S103 in FIG. 6, since it is judged that the recording area where the data is currently being recorded is the recordable area 112, the recording operation is continued.

At this time, if the embossed pits in the read-only area 111 recorded are reproduced, the RF signal shown in FIG. 10(a) is obtained. Namely, the preferable (or normal) RF signal to be obtained when the normal embossed pits are reproduced is obtained.

After that, it is assumed that the recording operation proceeds, and as shown in FIG. 9(b), the data is recorded by irradiating the laser light LB with the recording power, up to the read-only area 111 over the recordable area 112. At this time, on the LPP judgment device 401, it is judged that there is no land pre-pit LPP. Therefore, in the judgment in the step S103 in FIG. 6, since it is judged that the recording area where the data is currently being recorded is not the recordable area 112, it is judged that the data is mistakenly recorded. Therefore, the recording operation is temporarily stopped to erase the mistakenly recorded data.

In particular, the judgment in the step S103 in FIG. 6 (i.e. the judgment of whether or not the recording area where the data is currently being recorded is the recordable area 112) is performed in real time in parallel with the recording operation. Therefore, it is possible to detect the mistakenly recording of the data into the read-only area 111, more quickly.

At this time, if the embossed pits in the recording area where the data is mistakenly recorded (i.e. the mistakenly recorded portion in FIG. 9(b)) out of the read-only area 111 are reproduced, the RF signal shown in FIG. 10(b) is obtained. Namely, such a RF signal that the desired data can be hardly read or cannot be read due to the interference between the preformed embossed pits and the mistakenly recorded data (record marks) is obtained. This is not preferable because the data recorded as the embossed pits cannot be read. In the same manner, the data newly recorded as the record marks cannot be also read, so it is not preferable.

Incidentally, it is preferable to store address information indicating the position of the recording area where the data is mistakenly recorded. Namely, it is preferable to store the address information indicating the position of the entire mistakenly recorded portion, or the address information indicating the position of an end edge of the mistakenly recorded portion, or the like. This is realized by obtaining the address information indicating the position of the recording area where the data is recorded at the time point when it is judged that the recording area where the data is currently being recorded is not the recordable area 112 in the step S103 in FIG. 6. Specifically, the address information in the record data is stored into the memory. Then, on the basis of the address information, the mistakenly recorded data is erased preferably (i.e. without erasing other unrelated data or the like).

Then, as shown in FIG. 9(c), the mistakenly recorded data is DC erased (i.e. erased) by irradiating the laser light LB with a DC power, for example. At this time, in the LPP judgment device 401, the switch 413 is changed to the second reference voltage supplier 415 side, and it is subsequently judged whether or not the land pre-pit LPP exists. Then, in the middle of the erasing operation shown in FIG. 9(c), it is judged that there is no land pre-pit LPP. Therefore, since it is judged that the recording area where the data is currently being erased is the read-only area 111, the erasing operation is continued.

At this time, if the embossed pits in the recording area where the mistakenly recorded data is erased out of the read-only area 111 are reproduced, the RF signal shown in FIG. 10(c) is obtained. Namely, if the mistakenly recorded data is erased, it is possible to obtain substantially the same RF signal as the preferable RF signal shown in FIG. 10(a).

Incidentally, the mistakenly recorded data is erased preferably on the basis of the address information indicating the position of the recording area where the data is mistakenly recorded and which is stored in the information recording/reproducing apparatus 300.

After that, it is assumed that the erasing operation proceeds, and as shown in FIG. 9(d), the data recorded in the recordable area 112 is erased over the read-only area 111. At this time, in the LPP judgment device 401, it is judged that there is the land pre-pit LPP. Therefore, since it is judged that the recording area where the data is currently being erased is not the read-only area 111, it is judged that the data is mistakenly erased, unless there are special circumstances such as a user's instruction to erase the data. Therefore, the erasing operation is stopped to record the mistakenly erased data. Even in this case, as in the erasing of the mistakenly recorded data, it is preferable to store the address information indicating the position of the recording area where the data is mistakenly erased. Then, on the basis of the address information, it is preferable to record again the mistakenly erased data into the preferable recording area (i.e. without recording or overwriting the data or the like into other unrelated recording areas or the like).

As described above, even if the data is mistakenly recorded into the read-only area 111 in which the embossed pits or the like are formed in advance, it is possible to detect the mistakenly recording of the data. Then, since the mistakenly recorded data is erased, there is also such a great advantage that the embossed pits can be preferably reproduced. Moreover, even if the data recorded in the recordable area 112 is mistakenly erased, it is possible to detect the mistakenly erasing of the data. Then, since the mistakenly erased data is recorded again, there is not any particular problem when the data recorded in the recordable area 112 is reproduced.

In addition, by using the 14T mark or 14T space included in the RF signal as the gate signal, it is possible to eliminate the influence of the noise component or the like included in the LPP signal, and to highly accurately judge whether or not the land pre-pit LPP exists. As a result, it is possible to highly accurately judge whether or not the recording area where the data is recorded is the recordable area 112, so that it is possible to detect the mistakenly recording or mistakenly erasing of the data, more highly accurately.

### SECOND EMBODIMENT

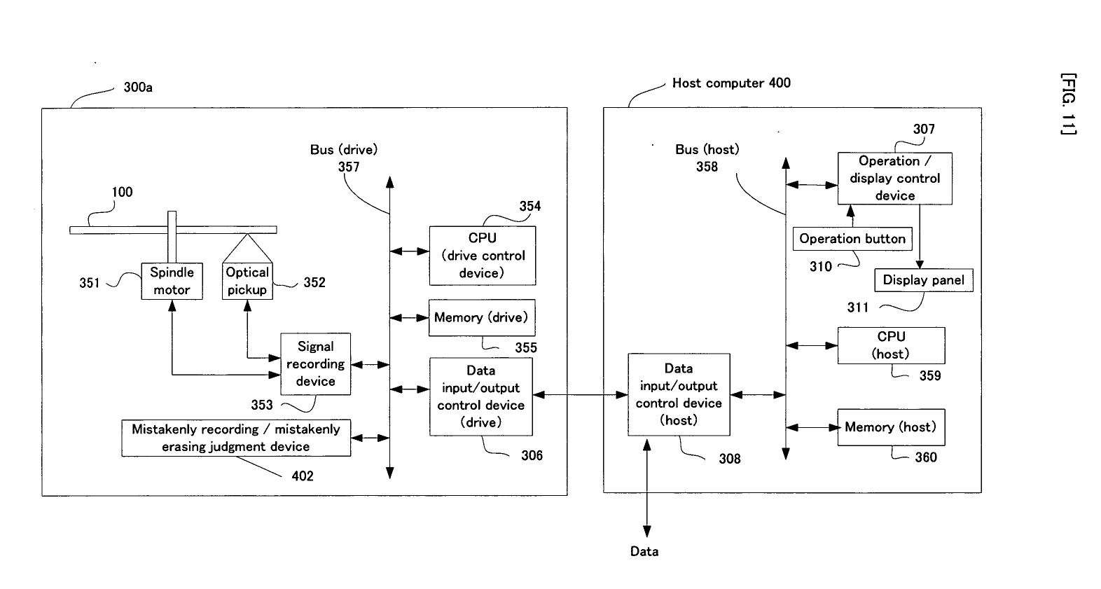

Next, with reference to FIG. 11 to FIG. 17, the second embodiment of the information recording apparatus of the present invention will be explained. Incidentally, the same structure and operation as those of the information recording apparatus in the first embodiment carry the same numerical reference and step number, and the detailed explanation thereof will be omitted.

(1) Basic Structure

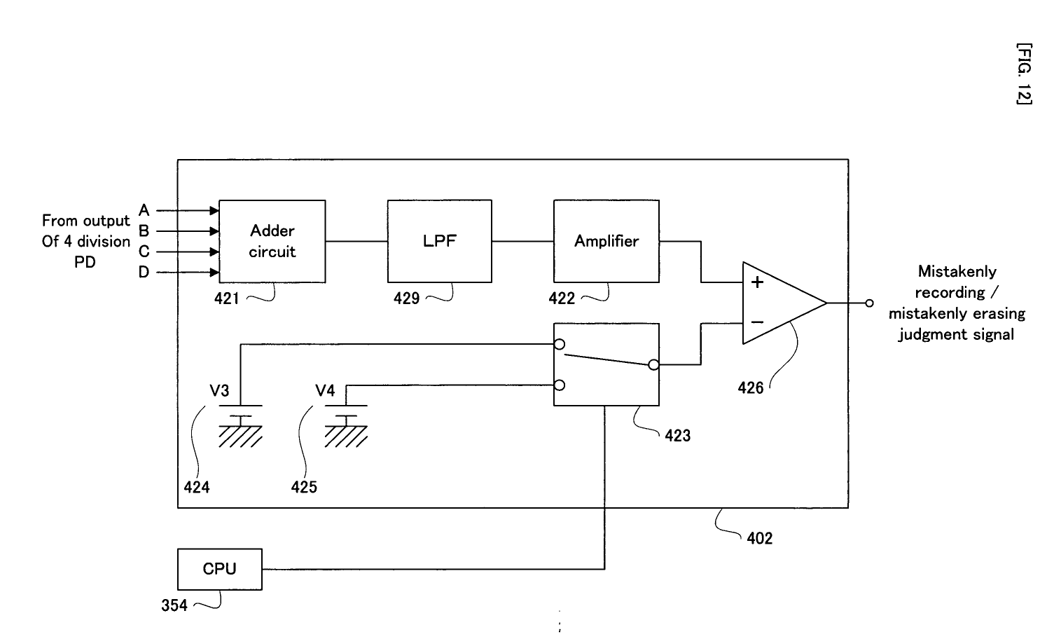

Firstly, with reference to FIG. 11 and FIG. 12, the basic structure of the information recording apparatus in the second embodiment will be explained. FIG. 11 is a block diagram showing the basic structure of a host computer and the information recording apparatus in the second embodiment. FIG. 12 is a block diagram showing the basic structure of a mistakenly recording/mistakenly erasing detector provided for the information recording apparatus in the second embodiment.

As shown in FIG. 11, an information recording apparatus 300a also has substantially the same structure as that in the first embodiment.

Particularly, the information recording apparatus 300a is provided with a mistakenly recording/mistakenly erasing detector 402, which constitutes one specific example of the “detecting device” of the present invention, instead of the LPP judgment device 401 provided for the information recording apparatus 300 in the first embodiment. The mistakenly recording/mistakenly erasing detector 402 is adapted to detect the mistakenly recording of the data into the read-only area 111, or detect the mistakenly erasing of the data recorded in the readable area 112. The mistakenly recording/mistakenly erasing detector 402 will be detailed with reference to FIG. 12.

As shown in FIG. 12, the mistakenly recording/mistakenly erasing detector 402 is provided with: an adder circuit 421; an amplifier 422; a switch 423; a first reference voltage supplier 424; a second reference voltage supplier 425; a comparator 426; and a LPF (Low Pass Filter) 429.

The adder circuit 421 is adapted to calculate (a+b+c+d) by using the divisional read signals a, b, c, and d and generate a sum signal SRF.

The amplifier 422 is adapted to amplify the sum signal SRF with a high-frequency component removed, outputted from the LPF 429 described later. Then, the amplified sum signal SRF is inputted to one of the input terminals of the comparator 426.

The switch 423, as in the first embodiment, is adapted to change a reference voltage inputted to the other input terminal of the comparator 426 to either a voltage V3 which is the output of the first reference voltage supplier 424 or a voltage V4 which is the output of the second reference voltage supplier 425.

The first reference voltage supplier 424, as in the first embodiment, is adapted to output the voltage V3, which is one specific example of the “predetermined first threshold value” of the present invention, as the reference voltage inputted to the other input terminal of the comparator 426. In particular, the voltage V3 outputted from the first reference voltage supplier 424 is inputted to the other input terminal of the comparator 426 when the information recording apparatus 300a records the data. Moreover, with regard to the value of the voltage V3, it is preferable to specify a more proper predetermined value, individually and specifically (e.g. depending on the average level of the sum signal SRF as described later), experimentally, experientially, mathematically or theoretically, or using simulations or the like, depending on the characteristics of the actually recorded data.

The second reference voltage supplier 425, as in the first embodiment, is adapted to output the voltage V4, which is one specific example of the “predetermined second threshold value” of the present invention, as the reference voltage inputted to the other input terminal of the comparator 426. In particular, the voltage V4 outputted from the second reference voltage supplier 425 is inputted to the other input terminal of the comparator 426 when the information recording apparatus 300a erases the data. Moreover, with regard to the value of the voltage V4, it is preferable to specify a more proper predetermined value, individually and specifically (e.g. depending on the average level of the sum signal SRF as described later), experimentally, experientially, mathematically or theoretically, or using simulations or the like, depending on the characteristics of the actually erased data.

The comparator 426 constitutes one specific example of the “first level judging device” and the “second level judging device” of the present invention. The comparator 426 is adapted to compare the sum signal SRF outputted from the amplifier 422 with the voltage V3 outputted from the first reference voltage supplier 424 or the voltage V4 outputted from the second reference voltage supplier 425, to thereby output a mistakenly recording/mistakenly erasing judgment signal.

The LPF 429 removes the high-frequency component of the sum signal SRF generated on the adder circuit 421. In other words, the LPF 429 is adapted to equalize the sum signal SRF and generate a signal component having the average level. Then, the LPF 429 is adapted to output the sum signal SRF with the high-frequency component removed, to the amplifier 422.

Incidentally, the information recording apparatus 300a in the second embodiment may have the function of reproducing the data, as in the information recording apparatus 300 in the first embodiment.

(2) Recording Operation Example

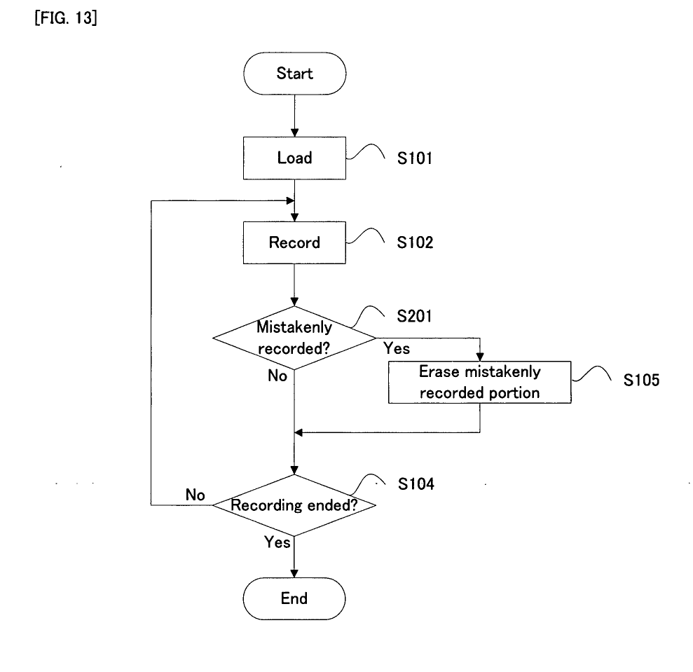

Next, with reference to FIG. 13 to FIG. 17, the recording operation by the information recording apparatus in the second embodiment will be explained. Here, firstly, FIG. 13 is referred to for explanation of the general recording operation, and then, the other drawings are used for detailed explanation. FIG. 13 is a flowchart showing a flow of the entire recording operation of the information recording apparatus in the second embodiment.

As shown in FIG. 13, firstly, the optical disc 100 is loaded on the information recording apparatus 300 (step S101). Then, data is actually recorded onto the optical disc 100 (step S102).

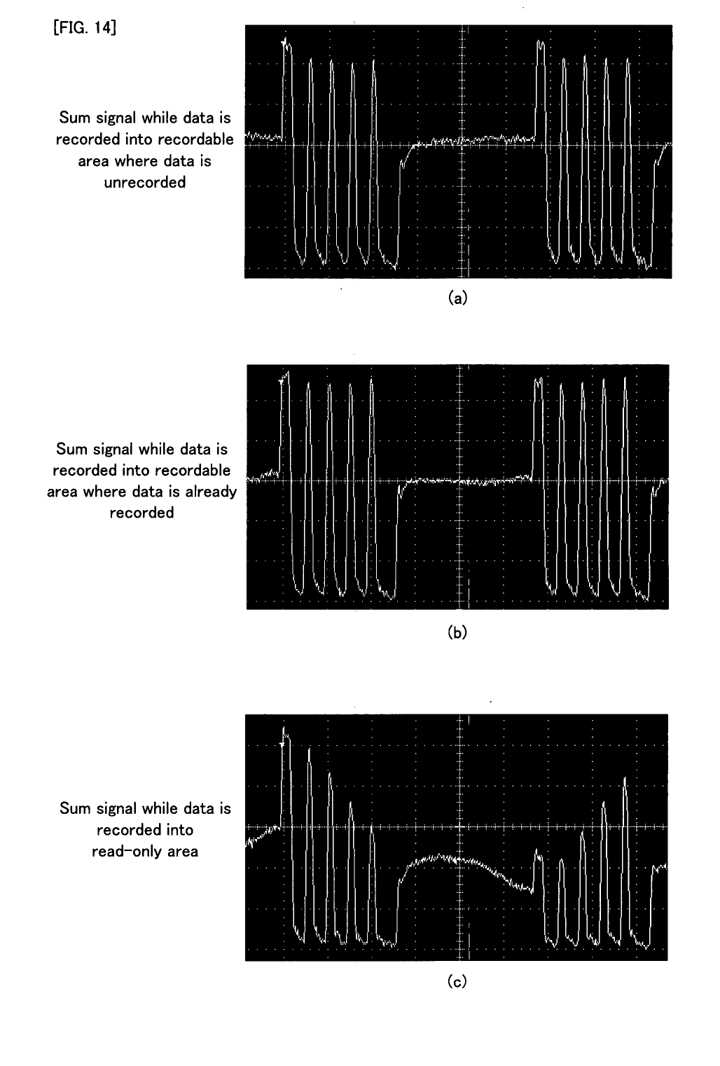

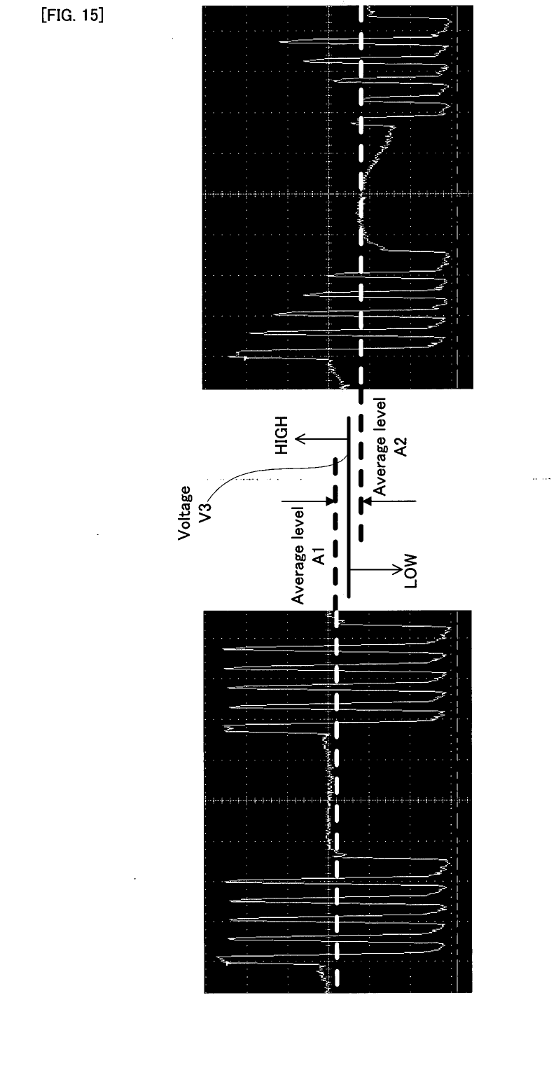

At this time, in parallel with the recording operation, it is judged whether or not the data is mistakenly recorded in the read-only area 111 (step S201). The judgment operation will be detailed later (refer to FIG. 14 and FIG. 15).

As a result of the judgment, if it is judged that the data is not mistakenly recorded (the step S201: No), then, it is judged whether or not to end the recording operation (step S104). As a result of this judgment, if it is judged not to end the recording operation (the step S104: No), the operational flow returns to the step S102 again to continue the recording operation. On the other hand, if it is judged to end the recording operation (the step S104: Yes), the recording operation is ended, and if necessary, a finalize process for the optical disc 100 may be performed, or the optical disc 100 may be ejected from the information recording apparatus 300.

On the other hand, as a result of the judgment in the step S201, if it is judged that the data is mistakenly recorded (the step S201: Yes), the recording operation of recording the data is temporarily stopped, and then, the mistakenly recorded data is erased (step S105).

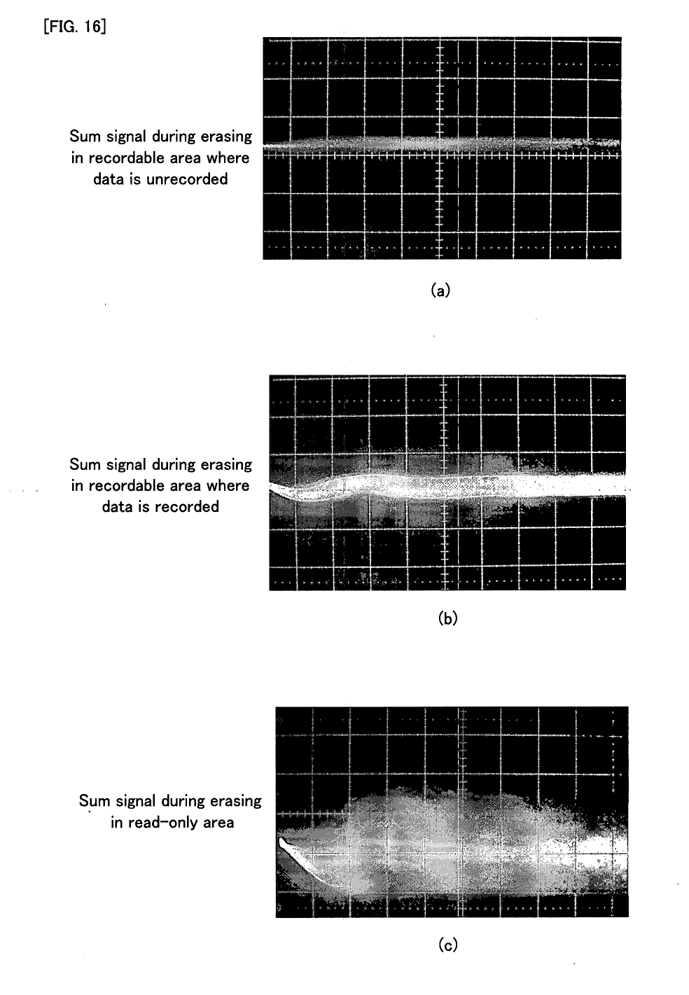

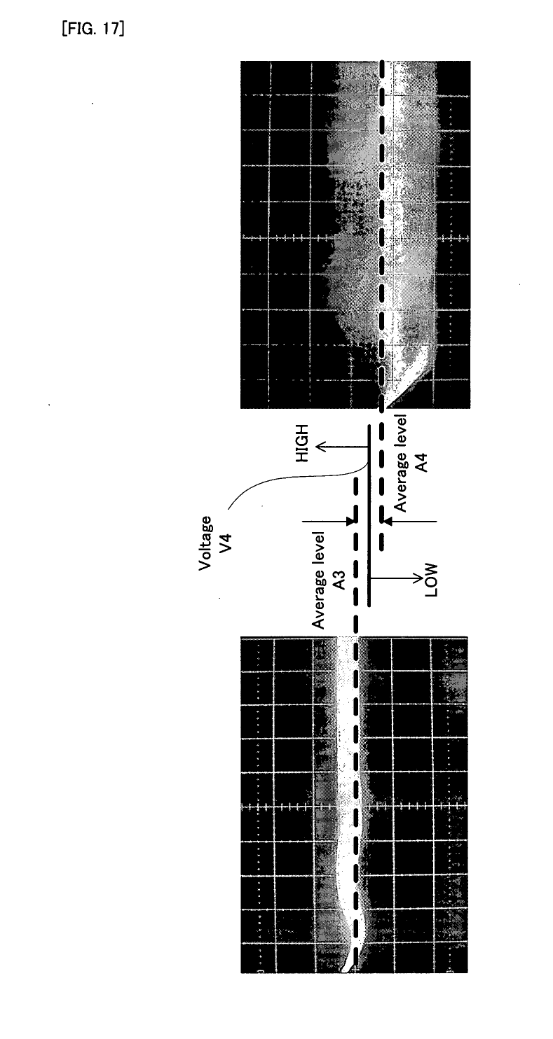

Even in the erasing operation of erasing the mistakenly recorded data, it is preferably judged whether or not the data recorded in the recordable area 112 is mistakenly erased. The judgment operation will be detailed later (refer to FIG. 16 and FIG. 17).

If it is judged that it is not mistakenly erased, the erasing operation may be continued as it is. If it is judged that it is mistakenly erased, the erasing operation-is preferably stopped to record the mistakenly erased data again, as in the erasing of the mistakenly recorded data.

Next, with reference to FIG. 14 to FIG. 17, an explanation will be given for the judgment operation of whether or not it is mistakenly recorded in the step S201 in FIG. 13, and for the judgment operation of whether or not it is mistakenly erased. FIG. 14 are signal waveform diagrams showing the sum signal during the data recording. FIG. 15 is an explanatory diagram explaining a principle of detecting the mistakenly recording of the data on the basis of the sum signal during the data recording. FIG. 16 are signal waveform diagrams showing the sum signal during the data erasing. FIG. 17 is an explanatory diagram explaining a principle of detecting the mistakenly erasing of the data on the basis of the sum signal during the data erasing.

FIG. 14(a) shows the sum signal SRF when the data is recorded into the recordable area 112 where the data is unrecorded (i.e. when the laser light LB with the recording power is irradiated).

Moreover, FIG. 14(b) shows the sum signal SRF when the data is further recorded (i.e. overwritten) into the recordable area 112 where the data is recorded. This sum signal SRF is substantially equal to the sum signal SRF shown in FIG. 14(a).

On the other hand, FIG. 14(c) shows the sum signal SRF when the data is recorded into the read-only area 111 where the embossed pits are formed (i.e. when the data is mistakenly recorded into the read-only area 111). As shown in FIG. 14(c), the sum signal SRF when the data is mistakenly recorded into the read-only area 111 is significantly different from the sum signals SRF shown in FIG. 14(a) and FIG. 14(b). This is because the reflected light when the recording is performed changes due to an influence of the embossed pits formed in advance.

Therefore, on the basis of the difference in the sum signal SRF, it can be judged whether or not the data is mistakenly recorded into the read-only area 111. In other words, it can be judged whether the recording area where the data is recorded is the recordable area 112 or the read-only area 111. For example, if the waveform of the sum signal SRF shown in FIG. 14(a) and FIG. 14(b) is obtained by monitoring the sum signal SRF, it can be judged that the data is not mistakenly recorded into the read-only area 111. If the waveform of the sum signal SRF shown in FIG. 14(c) is obtained, it can be judged that the data is mistakenly recorded in the read-only area 111.

Specifically, as shown in FIG. 15, by using the fact that the average level A1 of the sum signal SRF when the data is recorded into the recordable area 112 is different from the average level A2 of the sum signal SRF when the data is recorded into the read-only area 111, it is judged whether or not the data is mistakenly recorded into the read-only area 111. For example, a voltage less than the A1 and greater than A2 is inputted as the voltage V3 inputted to the other input terminal of the comparator 426 during the data recording operation. In this case, if a positive value (or HIGH level) is outputted as the output of the comparator 426, it can be judged that the sum signal SRF when the data is recorded into the recordable area 112 is outputted from the adder circuit 421, as shown in FIG. 14(a) and FIG. 14(b). Therefore, in this case, it is judged that the data is not mistakenly recorded into the read-only area 111. On the other hand, if a negative value (or LOW level) is outputted as the output of the comparator 426, it can be judged that the sum signal SRF when the data is recorded into the read-only area 111 is outputted from the adder circuit 421, as shown in FIG. 14(c). Therefore, in this case, it is judged that the data is mistakenly recorded into the read-only area 111.

As described above, on the basis of the sum signal SRF, it can be judged whether or not the data is mistakenly recorded into the read-only area 111, relatively easily.

The same is true for the sum signal SRF when the data is erased. Namely, FIG. 16(a) shows the sum signal SRF when the recordable area 112 where the data is unrecorded is irradiated with the laser light LB having the erasing power (i.e. when it is operated as if the data which is not actually recorded were erased).

Moreover, FIG. 16(b) shows the sum signal SRF when the recordable area 112 where the data is recorded is irradiated with the laser light LB having the erasing power (i.e. when the data actually recorded is erased). This sum signal SRF is slightly influenced by the data which is actually erased; however, it can be said that it is not so different from the sum signal SRF shown in FIG. 16(a).

On the other hand, FIG. 16(c) shows the sum signal SRF when the read-only area 111 where the embossed pits are formed is irradiated with the laser light LB having the erasing power. As shown in FIG. 16(c), the sum signal SRF when the read-only area 111 is irradiated with the laser light LB having the erasing power is significantly different from the sum signals SRF shown in FIG. 16(a) and FIG. 16(b). This is because the reflected light of the irradiating laser light LB changes due to the influence of the embossed pits formed in advance.

Therefore, on the basis of the difference in the sum signal SRF, it can be judged whether or not the data recorded in the recordable area 112 is mistakenly erased. In other words, it can be judged whether the recording area where the data is erased is the read-only area 111 or the recordable area 112. For example, if the waveform of the sum signal SRF shown in FIG. 16(a) and FIG. 16(b) is obtained by monitoring the sum signal SRF, it can be judged that the data recorded in the recordable area 112 is mistakenly erased. If the waveform of the sum signal SRF shown in FIG. 16(c) is obtained, it can be judged that the data recorded in the recordable area 112 is not mistakenly erased.

Specifically, as shown in FIG. 17, using the fact that the average level A3 of the sum signal SRF when the data in the recordable area 112 is erased is different from the average level A4 of the sum signal SRF when the data in the read-only area 111 is erased, it is judged whether or not the data recorded in the recordable area 112 is mistakenly erased. For example, a voltage less than the A3 and greater than A4 is inputted as the voltage V4 inputted to the other input terminal of the comparator 426 during the data erasing operation. In this case, if a positive value (or HIGH level) is outputted as the output of the comparator 426, it can be judged that the sum signal SRF when the data recorded in the recordable area 112 is erased is outputted from the adder circuit 421, as shown in FIG. 16(a) and FIG. 16(b). Therefore, in this case, it is judged that the data is mistakenly erased in the recordable area 112. On the other hand, if a negative value (or LOW level) is outputted as the output of the comparator 426, it can be judged that the sum signal SRF when the data recorded in the read-only area 111 is erased is outputted from the adder circuit 421, as shown in FIG. 16(c). Therefore, in this case, it is judged that the data recorded in the recordable area 112 is not mistakenly erased.

As described above, on the basis of the sum signal SRF, it can be judged whether or not the data recorded in the recordable area 112 is mistakenly erased, relatively easily.

Furthermore, in the embodiments, the optical disc 100 is explained as one example of the information recording medium, and the recorder related to the optical disc 100 is explained as one example of the information recording apparatus. The present invention, however, is not limited to the optical disc and the recorder thereof, but can be applied to other various information recording media supporting high-density recording or high transmission rates, and the recorders thereof.

The present invention is not limited to the above-described embodiments, and various changes may be made, if desired, without departing from the essence or spirit of the invention which can be read from the claims and the entire specification. An information recording medium, an information recording apparatus and method, and a computer program for recording control, all of which involve such changes, are also intended to be within the technical scope of the present invention.

### INDUSTRIAL APPLICABILITY

The information recording apparatus and method, and the computer program according to the present invention can be applied to a high-density optical disc, such as a DVD, and further to an information recording apparatus, such as a DVD recorder. Moreover, they can be applied to an information recording apparatus or the like which is mounted on various computer equipment for consumer use or for commercial use, or which can be connected to various computer equipment.

1. An information recording apparatus for recording record information onto an information recording medium comprising: a first area to record therein the record information; and a second area in which the record information is prerecorded as embossed pits,
said information recording apparatus comprising:
a recording device for recording the record information into the first area;
a detecting device for detecting that the record information is mistakenly recorded in the second area by said recording device; and
an erasing device for erasing the mistakenly recorded record information.

2. The information recording apparatus according to claim 1, wherein
said detecting device further detects that the record information recorded in the first area is mistakenly erased by said erasing device, and
said recording device records the mistakenly erased record information.

3. The information recording apparatus according to claim 1, wherein
pre-pits for controlling the recording of the record information are formed in the first area, and the pre-pits are not formed in the second area,
the information recording apparatus further comprises a pit judging device for judging whether or not the pre-pits can be read, and
said detecting device detects at least one of the mistakenly recording of the record information in the second area and the mistakenly erasing of the record information recorded in the first area, by judging whether a recording area where the record information is recorded or erased is the first area or the second area on the basis of whether or not the pre-pits can be read.

4. The information recording apparatus according to claim 3, wherein said pit judging device changes a slice level, which is a reference signal level when said pit judging device judges whether or not the pre-pits can be read, depending on whether the record information is recorded by said recording device or the record information is erased by said erasing device.

5. The information recording apparatus according to claim 3, wherein said detecting device detects that the record information is mistakenly recorded if it is judged that the recording area where the record information is recorded is the second area.

6. The information recording apparatus according to claim 3, wherein said detecting device detects that the record information recorded in the first area is mistakenly erased if it is judged that the recording area where the record information is erased is the first area.

7. The information recording apparatus according to claim 1, further comprising a timing judging device for judging whether or not timing at which a synchronization pattern included in the pre-pits appears is substantially equal to timing at which the synchronization pattern included in the record information which is a recording target appears, during the recording of the record information,
said pit judging device judging whether or not the pre-pits can be read by that said timing judging device judges whether or not the timings are substantially equal.

8. The information recording apparatus according to claim 7, wherein said timing judging device judges whether or not the timing at which the synchronization pattern included in the pre-pits appears is substantially equal to timing at which the synchronization pattern prepared in a pseudo manner appears, during the erasing of the mistakenly recorded record information.

9. The information recording apparatus according to claim 1, further comprising a first level judging device for judging whether or not an average value of a signal detection level when the record information is recorded is less than a predetermined first threshold value,
said detecting device detects, in a recording area where the average value that is less than the first threshold value is detected, that the record information is mistakenly recorded.

10. The information recording apparatus according to claim 1, further comprising a second level judging device for judging whether or not an average value of a signal detection level when the record information is erased is less than a predetermined second threshold value,
said detecting device detects, in a recording area where the average value that is greater than the second threshold value is detected, that the record information in the first area is mistakenly erased by said erasing device.

11. An information recording method of recording record information onto an information recording medium comprising: a first area to record therein the record information; and a second area in which the record information is prerecorded as embossed pits,
said information recording method comprising:
a recording process of recording the record information into the first area;
a detecting process of detecting that the record information is mistakenly recorded in the second area by said recording device; and
an erasing process of erasing the mistakenly recorded record information.

12. A computer program product in a computer-readable medium for tangibly embodying a program of instructions executable by a computer provided in an information recording apparatus, the computer program making the computer function as at least one portion of a recording device, a detecting device, and an erasing device,
said information recording apparatus for recording record information onto an information recording medium comprising: a first area to record therein the record information; and a second area in which the record information is prerecorded as embossed pits,
said information recording apparatus comprising:
said recording device for recording the record information into the first area;
said detecting device for detecting that the record information is mistakenly recorded in the second area by said recording device; and
said erasing device for erasing the mistakenly recorded record information.
